(19) United States
(12) Patent Application Publication
(10) Pub. No.: US 2024/0188554 A1
(43) Pub. Date: Jun. 13, 2024

(54) METHOD FOR APPLYING TWO DIFFERENT SPRAYS TO AGRICULTURAL LAND

(71) Applicant: Robert Bosch GmbH, Stuttgart (DE)

(72) Inventors: Johanna Link-Dolezal, Denkendorf (DE); Peter Schwaderer, Wildberg (DE)

(21) Appl. No.: 18/554,772

(22) PCT Filed: Apr. 5, 2022
(86) PCT No.: PCT/EP2022/058946

§ 371 Date: Oct. 10, 2023

(30) Foreign Application Priority Data
Apr. 21, 2021 (DE) 10 2021 203 937.5

(51) Int. Cl. A01M 7/00

(52) U.S. Cl. CPC A01M 7/0089; A01M 7/006; A01M 7/0085

(57) ABSTRACT

A method for applying two different sprays to agricultural land using an agricultural spraying device that includes a first spray circuit having a first spray tank and a first spray nozzle unit, and includes a second spray circuit, which is fluidically separate from the first spray circuit and has a second spray tank and a second spray nozzle unit. The method includes providing a first spray in the first spray tank. The method also includes providing a second spray in the second spray tank. The method also includes applying either the first spray using the first spray nozzle unit or the second spray using the second spray nozzle unit to field portions of the agricultural land depending on whether the at least one defined weed is present in each field portion.

### FIELD

The present invention relates to a method for applying two different sprays to agricultural land using an agricultural spraying device, and to a corresponding control unit and to an agricultural spraying device for applying two different sprays to agricultural land.

### BACKGROUND INFORMATION

Modern plant protection machinery has the technical specifications for applying a spray mixture to specific areas. These technical specifications include the ability to switch individual nozzles or part-widths on and off, the ability to couple the nozzle or part-width control to an application map or a suitable sensor system, and the ability to change the composition of the spray mixture depending on the weed population by feeding in additional plant protection products via direct injection. A sensor system of this kind can be a weed sensor, for example.

When blanket application is executed properly, each area of the field is treated with the target application amount (volume per unit area). In this case, the spray mixture is applied by a nozzle having defined properties in order to guarantee the effectiveness of the plant protection products (dispersal, droplet size, adhesion to site of action, etc.). In the case of application to specific areas, the appropriate specifications must also be ensured so as to guarantee the effectiveness of the plant protection product.

Essentially, there are two classes of plants when it comes to weeds: grasses (monocotyledons) and weeds (dicotyledons). These differ from one another in terms of morphology and physiology (absorption of the active ingredient, transportation to the site of action, metabolization/activation of the active ingredient, site of action of herbicides). Depending on the weed class and species, therefore, different (selective) herbicides are possible for effective treatment.

As regards the absorption path of a herbicide, a distinction is drawn between soil herbicides (root) and leaf herbicides (cuticle). Whereas soil herbicides are predominantly applied to weeds that have not yet fully sprouted, leaf herbicides can be absorbed only via existing leaf mass. This means that soil herbicides have to be applied in a blanket manner (and as a precautionary measure/without indication) in the field, whereas leaf herbicides can be applied to specific areas depending on whether weeds are present.

The hardware available on plant protection machinery and the requirements of the different regions lead to different operating strategies or application logic sequences.

German Patent Application No. DE 10 2017 210 804 A1 describes a method for applying a spray to a field, the spray being applied depending on a degree of coverage in a defined weed region.

### SUMMARY

The present invention relates to a method for applying two different sprays to agricultural land using an agricultural spraying device that comprises a first spray circuit having a first spray tank and a first spray nozzle unit, and comprises a second spray circuit, which is fluidically separate from the first spray circuit and has a second spray tank and a second spray nozzle unit. According to an example embodiment of the present invention, the method includes:
providing a first spray in the first spray tank of the first spray circuit of the spraying device, wherein the first spray comprises or consists of at least one, in particular soil-active, plant protection product that is to be applied in a blanket manner, and at least one selective, in particular foliar-active, and/or at least one non-selective, in particular foliar-active, herbicide;
providing a second spray in the second spray tank of the second spray circuit of the spraying device, wherein the second spray comprises or consists of the same at least one, in particular soil-active, plant protection product that is to be applied in a blanket manner, and the same at least one selective, in particular foliar-active, and/or the same at least one non-selective, in particular foliar-active, herbicide corresponding to the first spray, and additionally at least one, in particular foliar-active, herbicide that is not contained in the first spray and is selective for at least one defined weed; and
applying either the first spray using the first spray nozzle unit or the second spray using the second spray nozzle unit to field portions of the agricultural land depending on whether the at least one defined weed is present in each field portion.

The present invention further relates to a control unit. According to an example embodiment of the present invention, the control unit is configured for carrying out the following steps:
receiving image information that represents field portions of agricultural land that have been captured using an optical capturing unit of an agricultural spraying device;
identifying at least one defined weed in the captured field portions by using the image information; and
outputting a control signal depending on whether at least one occurrence of the at least one defined weed is identified
   either to a first spray nozzle unit of the agricultural spraying device, in order to apply a first spray from a first spray tank via a first spray circuit of the agricultural spraying device to the relevant captured field portion, wherein the first spray comprises or consists of at least one, in particular soil-active, plant protection product that is to be applied in a blanket manner, and at least one selective, in particular foliar-active, and/or at least one non-selective, in particular foliar-active, herbicide;
   or to a second spray nozzle unit of the agricultural spraying device, in order to apply a second spray from a second spray tank via a second spray circuit, which is fluidically separate from the first spray circuit, of the agricultural spraying device to the relevant captured field portion, wherein the second spray comprises or consists of the same at least one, in particular soil-active, plant protection product that is to be applied in a blanket manner, and the same at least one selective, in particular foliar-active, and/or the same at least one non-selective, in particular foliar-active, herbicide corresponding to the first spray, and additionally at least one, in particular foliar-active, herbicide that is not contained in the first spray and is selective for at least one defined weed.

The present invention also relates to an agricultural spraying device for applying two different sprays to agricultural land. According to an example embodiment of the present invention, the spraying device comprises
a first spray circuit having a first spray tank and a first spray nozzle unit;
a second spray circuit, which is fluidically separate from the first spray circuit and has a second spray tank and a second spray nozzle unit;
an optical capturing unit for capturing field portions of the agricultural land; and
a control unit as described above.

The present invention also relates to a computer program that is configured for executing and/or controlling the steps of a control unit of the present invention as described above when the computer program is executed on a computer, and to a machine-readable storage medium comprising the computer program stored thereon.

The method according to the present invention may be used for agricultural spraying devices having two fluidically separate spray circuits, each having its own circuit-specific spray tank and circuit-specific spray nozzle unit. In this respect, the method according to the present invention provides an operating strategy that is adapted to the plant recognition performance (degree of classification) and the available hardware and that entails optimized distribution of spray in the two spray tanks, in order to achieve both high effectiveness and highly efficient consumption of spray. The recognition performance can, for example, be limited to identifying or classifying just one defined weed or just one defined group of weeds.

The method may be used for agricultural purposes but is not limited thereto. Within the context of the present invention, an agricultural purpose can be construed as a purpose that is directed to agricultural cultivation of crop plants.

In this case, the sprays are applied to agricultural land or land used for agriculture. This can include a field, an area under cultivation for plants, or even a parcel of such an area. The agricultural land can thus be arable land, grassland, or pasture. By way of example, the plants can be cultivated plants or crop plants of which the crop is used in agriculture (for example as food, feed, or energy crops), as well as weeds and grass weeds.

The sprays are applied during one, i.e., the same, treatment operation on the agricultural land.

Preferably, according to an example embodiment of the present invention, all the steps of the method are carried out during one movement, in particular during one drive or flight of the agricultural spraying device over the agricultural land.

Advantageously, the agricultural spraying device is configured for carrying out the method in an automated and/or autonomous manner in order to allow the agricultural land to be treated quickly, reliably, and efficiently.

In particular, according to an example embodiment of the present invention, the agricultural spraying device can be part of an agricultural sprayer or of plant protection machinery, or can be formed as an agricultural sprayer or as plant protection machinery. The agricultural spraying device can comprise a mobile unit or be arranged on a mobile unit, it being possible for the mobile unit to be formed in particular as a land-based vehicle and/or as an aircraft and/or as a trailer. The mobile unit can in particular be an agricultural work machine, for example a tractor, a hauler, a self-propelled or autonomous sprayer, or a self-propelled or autonomous robot. In particular, the agricultural spraying device can be a towed sprayer, a self-propelled sprayer, or a mounted sprayer. The agricultural spraying device can also be mounted on a hydraulic device of an agricultural work machine. It is also possible for the agricultural spraying device to be attached to a load bed of an agricultural work machine. Alternatively, the spraying device can be hitched to the agricultural work machine.

According to an example embodiment of the present invention, the agricultural spraying device has a first spray circuit for applying a first spray, and a second spray circuit, which is fluidically separate from the first spray circuit, for applying a second spray. In other words, the agricultural spraying device comprises two fluidically separate spray circuits for applying two different sprays. Accordingly, the two spray circuits are formed such that the two sprays do not mix or come into contact with one another within the spray circuits.

According to an example embodiment of the present invention, the first spray circuit has a circuit-specific first spray tank for the first spray, and a circuit-specific first spray nozzle unit for applying the first spray. It follows that the first spray circuit further comprises a corresponding first system of lines. The second spray circuit has a circuit-specific second spray tank for the second spray, and a circuit-specific second spray nozzle unit for applying the second spray. It follows that the second spray circuit further comprises a corresponding second system of lines. The first spray circuit and the second spray circuit can be configured or constructed substantially identically.

According to an example embodiment of the present invention, the spray nozzle units are configured to be controllable or actuable. In this respect, the spray nozzle units each have at least one spray nozzle, but preferably a multiplicity of spray nozzles and at least one valve each, preferably one valve assigned to each spray nozzle for controlling or regulating the amount of spray applied. The valves can be arranged or integrated in the spray nozzles. However, the valves can also be connected upstream of the spray nozzles, i.e., arranged upstream of the spray nozzles (in the flow direction of the spray). However, the spray nozzle units can also have a plurality of spray nozzles, each having one upstream valve. However, the spray nozzle units can also have a plurality of spray nozzles having just one valve connected upstream of the spray nozzles, such that when the valve is actuated, the spray is applied via a plurality of spray nozzles of the relevant spray nozzle unit. By way of example, the valves can be formed as pulse-width-modulated valves (PWM valves) or as proportional valves. The spray nozzles of each spray nozzle unit can be activatable individually or separately and/or in defined groups or groupings and/or all together.

Preferably, according to an example embodiment of the present invention, one spray nozzle each from the two spray nozzle units form a spray nozzle pair, the spray nozzles in a spray nozzle pair being formed so as to apply the respective sprays to the same field portion while the agricultural land is being treated or to treat the same field portion with the respective sprays. In this respect, the spray nozzles in a spray nozzle pair are preferably adjacent to one another, in particular are arranged one behind the other or one next to the other in the movement direction of the agricultural spraying device.

According to an example embodiment of the present invention, each field portion row (i.e., field portions in the direction of movement or travel) can be assigned at least one spray nozzle pair. For example, each field portion row can be assigned exactly one spray nozzle pair or exactly two adjacent spray nozzle pairs in order to treat said row.

The spray can be applied in particular using at least one delivery unit of the agricultural spraying device. In this case, the delivery unit can be configured for delivering or conducting, in particular dosing, a liquid under pressure. Accordingly, the delivery unit can comprise, for example, in each case one or more pumps, delivery pumps, dosing pumps, pressure accumulators, screw conveyors, valves, diaphragms, etc.

According to an example embodiment of the present invention, the agricultural spraying device can comprise an optical capturing unit for capturing field portions of the agricultural land in order to obtain in each case image information for identifying the at least one defined weed. The optical capturing unit is preferably arranged on the agricultural spraying device. The optical capturing unit can have at least one camera, preferably a plurality of cameras, which can be selected from the group including multispectral and/or hyperspectral and/or infrared and/or cameras and/or 3D cameras. The optical capturing unit can be configured for capturing or taking images in the NIR and/or visual range. The optical capturing unit can have a light or an illumination unit. The cameras can be configured for communicating with one another. Each field portion row can be assigned one camera. However, it is also possible that an optical capturing unit captures field portions of two or more field portion rows.

According to an example embodiment of the present invention, the spray nozzle units and the optical capturing unit are preferably arranged on a sprayer boom of the agricultural spraying device.

According to an example embodiment of the present invention, the captured field portion can be a capture portion or a captured image portion of an optical capturing unit. The captured field portion is preferably the entire field portion captured in the field of vision of the optical capturing unit.

Preferably, according to an example embodiment of the present invention, the image information is a photograph or an image of the captured field portion.

According to an example embodiment of the present invention, the two sprays are in particular liquid sprays. The liquid sprays can be formed, for example, as a liquid, a suspension, an emulsion, a solution, or a combination thereof. Preferably, the liquid sprays are diluted with water. The liquid sprays can be agricultural spray mixtures, for example.

According to an example embodiment of the present invention, the first spray comprises or consists of at least one plant protection product to be applied in a blanket manner, and at least one selective and/or at least one non-selective herbicide. The plant protection product to be applied in a blanket manner is preferably a soil-active plant protection product. The in particular soil-active plant protection product to be applied in a blanket manner can be selected from the group consisting of insecticides, fungicides, soil-active herbicides, non-selective and/or selective foliar-active herbicides, or combinations thereof. Preferably, the selective herbicide is a foliar-active herbicide. The selective herbicide can be selected from the group consisting of selective, primarily foliar-active herbicides against weeds, against grasses, or against certain weed species such as thistles, or combinations thereof. Preferably, the non-selective herbicide is likewise a foliar-active herbicide. The non-selective herbicide can be selected from the group consisting of total herbicides or non-specific, broad-spectrum herbicides, or combinations thereof.

Furthermore, according to an example embodiment of the present invention, the first spray can comprise a fertilizer, in particular a fertilizer concentrate, and/or a growth regulator and/or an insecticide and/or a fungicide and/or a further active agent.

According to an example embodiment of the present invention, the second spray comprises the same at least one, in particular soil-active, plant protection product that is to be applied in a blanket manner, and the same at least one selective, in particular foliar-active, and/or the same at least one non-selective, in particular foliar-active, herbicide corresponding to the first spray. The second spray additionally comprises at least one herbicide that is not contained in the first spray and is selective for at least one defined weed or defined weed species, for example thistles. Preferably, the selective herbicide is a foliar-active herbicide. Preferably, the herbicide of the second spray is selective for a defined group of weeds. The herbicide that is selective for the defined weed or the defined weed species or the defined group of weeds can be selected from the group consisting of selective, primarily foliar-active herbicides against weeds, against grasses, or against certain weed species such as thistles (unless one such herbicide is already contained in the spray), or combinations thereof.

Furthermore, according to an example embodiment of the present invention, the second spray can comprise a fertilizer, in particular a fertilizer concentrate, and/or a growth regulator and/or an insecticide and/or a fungicide and/or a further active agent.

According to an example embodiment of the present invention, in the applying step, either the first spray is applied to field portions, which in particular have been captured using the optical capturing unit, of the agricultural land using the first spray nozzle unit or the second spray is applied thereto using the second spray nozzle unit (such that all the field portions of the field are treated). The “spraying decision” in this respect is taken depending on whether the at least one defined weed is present in each field portion.

In the process, the corresponding spray is preferably applied to the entire field portion according to the number of spray nozzles assigned to the field portion row. The field portions or regions to which spray is applied will also be referred to below as sprayed or treated field portions.

According to an example embodiment of the present invention, a step of identifying the at least one defined weed in the captured field portions by using the corresponding image information by way of a control unit, in particular of the agricultural spraying device, is preferred. In this respect, the identifying step preferably comprises a step of classifying the identified weeds. The identifying step can furthermore comprise a step of identifying plant material.

According to an example embodiment of the present invention, the identifying step can comprise capturing a color component, in particular a green color component and/or an infrared component, in the field portion or the image information. In this respect, plants can be detected using the optical capturing unit, for example on the basis of a predetermined NDVI value (normalized difference vegetation index, formed from reflection values in the NIR and visible red wavelength range of the light spectrum), by distinguishing biomass or vital plants and plant parts from the soil.

Alternatively or additionally, however, according to an example embodiment of the present invention, a step of reading out and/or receiving corresponding position information of the at least one defined weed in relation to the agricultural land can be provided.

According to an example embodiment of the present invention, preferably, the first spray is applied if there is none of the at least one defined weed present and/or identified in the relevant field portion. Alternatively or additionally, the second spray is preferably applied if at least one occurrence of the at least one defined weed is present and/or identified. In this respect, however, a threshold value of greater than 1 can also be specified, above which a switchover to the second spray or to the second spray nozzle unit is carried out.

Advantageously, this specific example embodiment of the present invention can be carried out using an optical capturing unit and an arithmetic logic unit that are configured for identifying and classifying only the at least one defined weed or only the defined group of weeds.

According to an example embodiment of the present invention, a field portion or the image information of a field portion can comprise a plurality of separate image evaluation regions in which the defined weeds are identified. The number of image evaluation regions per piece of image information can be dependent on the distance between the spray nozzles and the width of the image information. Each image evaluation region can in each case be assigned to one or more spray nozzle pairs. For example, for an image information width of 1.5 m and for a distance of 0.25 m between the spray nozzles, six image evaluation regions per camera can be provided.

According to an example embodiment of the present invention, the sprays are preferably applied to the field portions substantially uniformly. Within the context of the present invention, uniform application can mean application at the same or constant, predefined application amount per unit area. A predefined application amount can be construed as an application amount that is set in advance or at the start of the treatment. The defined application amount can be preset or can be input in advance.

It goes without saying that the method steps of capturing the field portions, identifying the at least one defined weed, and applying the sprays are carried out repeatedly. In this respect, preferably the steps of capturing the field portions are carried out, or repeatedly carried out, in a defined, in particular fixed, time period or a time period adapted to the driving speed of the agricultural spraying device. In other words, the field portions are captured at a defined or speed-dependent repetition rate.

According to an example embodiment of the present invention, the control unit can comprise an arithmetic logic unit or a multiplicity of arithmetic logic units for processing signals or data, at least one storage unit for storing signals or data, and at least one communication interface for inputting data, in particular for receiving image information and for outputting data, in particular control signals, to a unit, in particular an actuator. Each optical capturing unit or each camera can be assigned one arithmetic logic unit, or each optical capturing unit or each camera can comprise its own arithmetic logic unit. The arithmetic logic unit(s) is/are designed or configured for image processing such that they can carry out calculation steps or image processing steps for carrying out the method according to the present invention. Accordingly, each arithmetic logic unit has a corresponding piece of image processing software. By way of example, the arithmetic logic unit can be a signal processor, a microcontroller, or the like, it being possible for the storage unit to be a flash memory, an EPROM, or a magnetic storage unit. The communication interface can be configured for inputting or outputting data in a wireless and/or wire-bound manner; a communication interface that can input or output wire-bound data can, for example, input these data electrically or optically from a corresponding data transmission line or output them into a corresponding data transmission line.

Accordingly, the method according to an example embodiment of the present invention can, for example, be implemented in the control unit or a controller in software or hardware or in a mixed form of software and hardware.

According to an example embodiment of the present invention, the control unit can be fully or partly arranged on or integrated in the agricultural spraying device. However, the control unit can also be fully or partly external, for example integrated in a cloud.

### BRIEF DESCRIPTION OF THE DRAWINGS

The present invention will be explained by way of example in more detail below on the basis of the figures.

FIG. 1 is a schematic illustration of an agricultural spraying device, according to an example embodiment of the present invention.

FIG. 2 is a schematic detailed view of two spray circuits, according to an example embodiment of the present invention.

FIG. 3 shows image information containing identified weeds in a defined weed group according to an example embodiment according to the present invention.

FIG. 4 is a flowchart of a method according to an example embodiment of the present invention.

### DETAILED DESCRIPTION OF EXAMPLE EMBODIMENTS

In the following description of preferred exemplary embodiments of the present invention, the same or similar reference numerals are used for the elements shown in the various figures that have the same action, the description of these elements not being repeated.

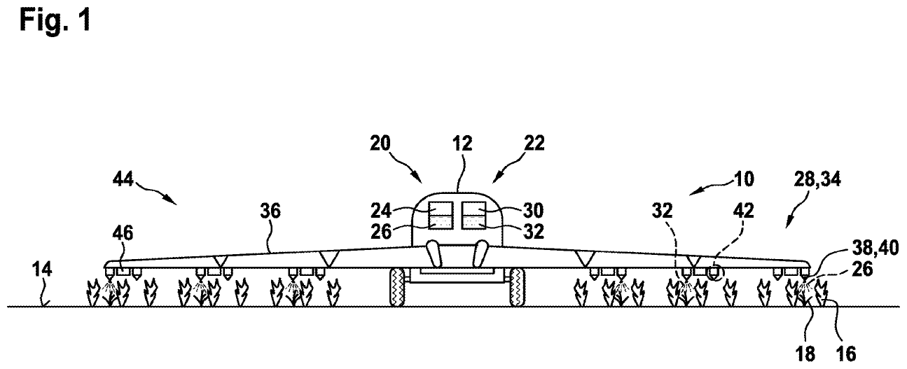

FIG. 1 is a schematic illustration of an agricultural spraying device, denoted as a whole by reference numeral 10.

The agricultural spraying device 10 is formed as a sprayer 10. The sprayer 10 is arranged on a mobile land-based vehicle 12, formed as a tractor 12 or farming tractor 12.

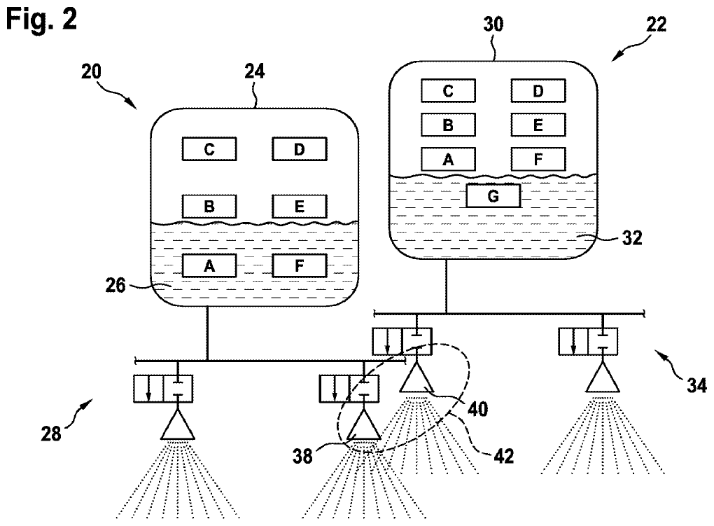

The agricultural spraying device 10 is configured for applying two different sprays to agricultural land 14 containing cultivated plants 16 and weeds 18. For this purpose, the agricultural spraying device 10 has two spray circuits 20, 22, which are shown in more detail in FIG. 2 and will be described in more detail hereinafter.

The first spray circuit 20 has a first spray tank 24 containing a first spray 26 and a first spray nozzle unit 28 for applying the first spray 26. Analogously, the second spray circuit 22 has a second spray tank 30 containing a second spray 32 and a second spray nozzle unit 34 for applying the second spray 32.

The two spray nozzle units 28, 34 each have a multiplicity of spray nozzles 38, 40 arranged on a sprayer boom 36 at a distance from one another in the longitudinal direction. In each case, one spray nozzle 38 of the first spray nozzle unit 28 and one spray nozzle 40 of the second spray nozzle unit 34 form a spray nozzle pair 42, the spray nozzles 38, 40 in one spray nozzle pair 42 being arranged adjacent to one another and one behind the other in the movement direction of the agricultural spraying device 10.

According to the present invention, the first spray 26 consists of two soil-active plant protection products A, B that are to be applied in a blanket manner, and four selective and/or non-selective foliar-active herbicides C-F. In addition, according to the present invention, the second spray 32 consists of the same two soil-active plant protection products A, B that are to be applied in a blanket manner, and the same four selective and/or non-selective foliar-active herbicides C-F corresponding to the first spray 26, plus a foliar-active herbicide G that is not contained in the first spray 26 and is selective for a defined group of weeds 18.

The agricultural spraying device 10 additionally comprises an optical capturing unit 44 for capturing field portions of the agricultural land 14 in order to obtain in each case image information for identifying the at least one defined weed 18 or a defined group of weeds 18. The optical capturing unit 44 has a multiplicity of optical cameras 46 arranged on the sprayer boom 36 at a distance from one another in the longitudinal direction. The optical cameras 46 each comprise a filter unit in order to extract a color component, for example the green color component, from an obtained or captured piece of image information or a captured image, in order to detect weeds 18.

Furthermore, the agricultural spraying device 10 comprises a control unit (not shown) that is connected to the optical cameras 46 in order to receive information therefrom. The control unit has a multiplicity of arithmetic logic units, which are each assigned to one optical camera 46 and further configured for carrying out calculation steps or image processing steps in order to carry out the method according to the present invention, in particular for identifying the at least one defined weed 18 by using the image information from the corresponding optical camera 46. The control unit is further configured for outputting a control signal depending on whether at least one occurrence of the at least one defined weed 18 is identified, in such a way that either the first spray 26 or the second spray 32 is applied.

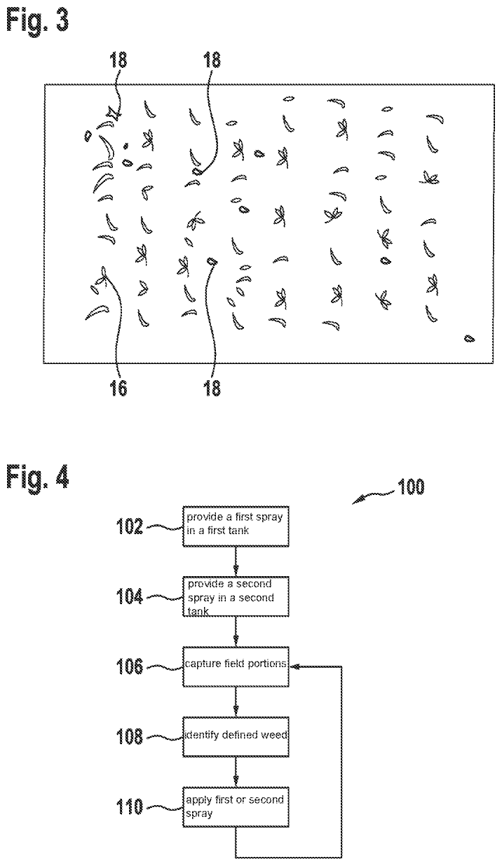

FIG. 3 shows a specific embodiment in which the optical cameras 46 and the associated arithmetic logic units are configured for identifying or classifying just one defined group of weeds 18.

FIG. 4 is a flowchart of a method 100 for applying two different sprays 26, 32 to agricultural land 14 using an agricultural spraying device 10 that comprises a first spray circuit 20 having a first spray tank 24 and a first spray nozzle unit 28, and comprises a second spray circuit 22, which is fluidically separate from the first spray circuit and has a second spray tank 30 and a second spray nozzle unit 34. The method comprises a step of providing 102 a first spray 26 in the first spray tank 24 of the first spray circuit 20 of the spraying device 10, wherein the first spray 26 comprises or consists of at least one, in particular soil-active, plant protection product A, B that is to be applied in a blanket manner, and at least one selective, in particular foliar-active, and/or at least one non-selective, in particular foliar-active, herbicide C-F. The method 100 further comprises a step of providing 104 a second spray 32 in the second spray tank 30 of the second spray circuit 34 of the spraying device 10, wherein the second spray 32 comprises or consists of the same at least one, in particular soil-active, plant protection product A, B that is to be applied in a blanket manner, and the same at least one selective, in particular foliar-active, and/or the same at least one non-selective, in particular foliar-active, herbicide C-F corresponding to the first spray 26, and additionally at least one, in particular foliar-active, herbicide G that is not contained in the first spray 26 and is selective for at least one defined weed 18. The method 100 additionally comprises a step of capturing 106 the field portions of the agricultural land 14 using an optical capturing unit 44 of the agricultural spraying device 10 in order to obtain in each case image information for identifying the at least one defined weed 18. Furthermore, the method 100 comprises a step of identifying 108 the at least one defined weed 18 in the captured field portions by using the corresponding image information by way of a control unit, in particular of the agricultural spraying device 10. Lastly, the method 100 comprises a step of applying 110 either the first spray 26 using the first spray nozzle unit 28 or the second spray 32 using the second spray nozzle unit 34 to field portions of the agricultural land 14 depending on whether the at least one defined weed 18 is present in each field portion.

Where an exemplary embodiment contains an “and/or” link between a first feature and a second feature, this should be construed as meaning that according to one specific embodiment, the exemplary embodiment includes both the first feature and the second feature, and according to a further specific embodiment, the exemplary embodiment includes either only the first feature or only the second feature.

1-11. (canceled)

12. A method for applying two different sprays to agricultural land using an agricultural spraying device that includes a first spray circuit having a first spray tank and a first spray nozzle unit, and includes a second spray circuit, which is fluidically separate from the first spray circuit and has a second spray tank and a second spray nozzle unit, the method comprising the following steps:
providing a first spray in the first spray tank of the first spray circuit of the spraying device, wherein the first spray includes or consists of: (i) at least one soil-active, plant protection product that is to be applied in a blanket manner, and (ii) at least one selective foliar-active and/or at least one non-selective foliar-active herbicide;
providing a second spray in the second spray tank of the second spray circuit of the spraying device, wherein the second spray includes or consists of: (i) the same at least one soil-active plant protection product that is to be applied in a blanket manner, and the same at least one selective foliar-active, and/or (ii) the same at least one non-selective herbicide corresponding to the first spray, and additionally at least one foliar-active, herbicide that is not contained in the first spray and is selective for at least one defined weed; and
applying either the first spray using the first spray nozzle unit or the second spray using the second spray nozzle unit to field portions of the agricultural land depending on whether the at least one defined weed is present in each field portion.

13. The method as recited in claim 12, further comprising:
capturing the field portions of the agricultural land using an optical capturing unit of the agricultural spraying device to obtain in each case image information for identifying the at least one defined weed.

14. The method as recited in claim 13, further comprising:
(i) identifying the at least one defined weed in the captured field portions by using the corresponding image information by way of a control unit of the agricultural spraying device, and/or (ii) reading out and/or receiving corresponding position information of the at least one defined weed in relation to the agricultural land.

15. The method as recited in claim 12, wherein, in the applying step, the first spray is applied when there is none of the at least one defined weed present and/or identified in the relevant field portion.

16. The method as recited in claim 12, wherein, in the applying step, the second spray is applied when at least one occurrence of the at least one defined weed is present and/or identified.

17. The method as recited in claim 12, wherein the herbicide of the second spray is selective for a defined group of weeds.

18. A control unit configured to:
receive image information that represents field portions of agricultural land that have been captured using an optical capturing unit of an agricultural spraying device;
identify at least one defined weed in the captured field portions by using the image information; and
output a control signal, depending on whether at least one occurrence of the at least one defined weed is identified, selectively to:
a first spray nozzle unit of the agricultural spraying device, to apply a first spray from a first spray tank via a first spray circuit of the agricultural spraying device to a relevant captured field portion, wherein the first spray includes or consists of: (i) at least one soil-active, plant protection product that is to be applied in a blanket manner, and (ii) at least one selective foliar-active, and/or at least one non-selective, foliar-active herbicide; or
a second spray nozzle unit of the agricultural spraying device, to apply a second spray from a second spray tank via a second spray circuit, which is fluidically separate from the first spray circuit, of the agricultural spraying device to the relevant captured field portion, wherein the second spray includes or consists of: (i) the same at least one soil-active, plant protection product that is to be applied in a blanket manner, and (ii) the same at least one selective foliar-active, and/or the same at least one non-selective foliar-active, herbicide corresponding to the first spray, and additionally at least one foliar-active herbicide that is not contained in the first spray and is selective for at least one defined weed.

19. An agricultural spraying device for applying two different sprays to agricultural land, comprising:
a first spray circuit including a first spray tank and a first spray nozzle unit;
a second spray circuit, which is fluidically separate from the first spray circuit and includes a second spray tank and a second spray nozzle unit;
an optical capturing unit configured to capture field portions of the agricultural land; and
a control unit configured to:
receive image information that represents field portions of agricultural land that have been captured using an optical capturing unit of an agricultural spraying device;
identify at least one defined weed in the captured field portions by using the image information; and
output a control signal, depending on whether at least one occurrence of the at least one defined weed is identified, selectively to:
the first spray nozzle unit of the agricultural spraying device, to apply a first spray from the first spray tank via the first spray circuit of the agricultural spraying device to a relevant captured field portion, wherein the first spray includes or consists of: (i) at least one soil-active, plant protection product that is to be applied in a blanket manner, and (ii) at least one selective foliar-active, and/or at least one non-selective, foliar-active herbicide; or
the second spray nozzle unit of the agricultural spraying device, to apply a second spray from the second spray tank via the second spray circuit, which is fluidically separate from the first spray circuit, of the agricultural spraying device to the relevant captured field portion, wherein the second spray includes or consists of: (i) the same at least one soil-active, plant protection product that is to be applied in a blanket manner, and (ii) the same at least one selective foliar-active, and/or the same at least one non-selective foliar-active, herbicide corresponding to the first spray, and additionally at least one foliar-active herbicide that is not contained in the first spray and is selective for at least one defined weed.

20. The agricultural spraying device as recited in claim 19, wherein one spray nozzle each from the first and second spray nozzle units form a spray nozzle pair, the spray nozzles in a spray nozzle pair being formed so as to apply the first and second sprays to the same field portion.

21. A non-transitory machine-readable storage medium on which is stored a computer program for applying two different sprays to agricultural land using an agricultural spraying device that includes a first spray circuit having a first spray tank and a first spray nozzle unit, and includes a second spray circuit, which is fluidically separate from the first spray circuit and has a second spray tank and a second spray nozzle unit, the computer program, when executed by a computer, causing the computer to perform the following steps:
providing a first spray in the first spray tank of the first spray circuit of the spraying device, wherein the first spray includes or consists of: (i) at least one soil-active, plant protection product that is to be applied in a blanket manner, and (ii) at least one selective foliar-active and/or at least one non-selective foliar-active herbicide;
providing a second spray in the second spray tank of the second spray circuit of the spraying device, wherein the second spray includes or consists of: (i) the same at least one soil-active plant protection product that is to be applied in a blanket manner, and the same at least one selective foliar-active, and/or (ii) the same at least one non-selective herbicide corresponding to the first spray, and additionally at least one foliar-active, herbicide that is not contained in the first spray and is selective for at least one defined weed; and
applying either the first spray using the first spray nozzle unit or the second spray using the second spray nozzle unit to field portions of the agricultural land depending on whether the at least one defined weed is present in each field portion.
